(19) United States
(12) Patent Application Publication
(10) Pub. No.: US 2017/0169392 A1
(43) Pub. Date: Jun. 15, 2017

(54) AUTOMATIC BILL OF TALENT GENERATION

(71) Applicant: HCL America Inc., Sunnyvale, CA (US)

(72) Inventors: Rajesh Ramesh Agrawal, Chennai (IN); Ravindra S. Gajulapalli, Bangalore (IN); Prasad A. Chodavarapu, Bangalore (IN); Deepti Mittal, Kondapur (IN)

(21) Appl. No.: 15/443,414

(22) Filed: Feb. 27, 2017

Related U.S. Application Data
(63) Continuation of application No. 13/186,154, filed on Jul. 19, 2011, now abandoned.

(51) Int. Cl. G06Q 10/10; G06Q 10/06; G06F 17/30

(52) U.S. Cl. CPC G06Q 10/105; G06F 17/30312; G06Q 10/067; G06Q 10/0633; G06Q 10/063112

(57) ABSTRACT

A method and system comprising at least one database to store process model information comprising logical process model information and human resource dependency information. The human resource dependency information may indicate design-time dependence of process activities on respective human resource components and may comprise one or more role identifiers associated with at least some process activities and a set of role category identifiers associated with at least one of the role identifiers. The set of role category identifiers indicates a plurality of alternative role categories that are applicable to the corresponding role. The role mapping module is provided to receive user input to associate sets of role category editors with responding role identifiers. A bill generator may analyze the logical process model information and human resource dependency information in order to generate a human resource requirement bill that includes a listing of human resource roles and role categories required for performance of the process.

### PRIORITY

This Application is a Continuation of U.S. patent application Ser. No. 13/186,154, filed Jul. 19, 2011, which application is incorporated by reference herein its entirety.

### TECHNICAL FIELD

The present application relates generally to the technical field of methods and systems for modeling, analyzing and managing processes. An example embodiment relates to methods and systems to perform computer-assisted analysis of process models. A further example embodiment relates to automatic generation of a human resource requirement bill or bill of talent.

### BACKGROUND

Process modeling in systems engineering and software engineering relates generally to modeling or mapping a process or a number of processes in an enterprise. Such process modeling may facilitate analysis and improvement of the process, for example serving to facilitate analysis of a manufacturing process, a business process, or the like.

Process modeling may therefore be useful for process management. A process model may comprise structured information not only about the sequence and relationship of respective activities constituting a process or processes, but may also define relationships of process activities to other process elements or components, including human resources. In certain embodiments, a business process model may therefore be part of a larger encompassing enterprise model. The latter may facilitate enterprise resource and/or business process analysis and management.

A process model may also be used to generate a graphical representation of process information. Visual modeling languages used to represent processes include Business Process Modeling Notation (BPMN) and the Event-driven Process Chain (EPC), although any suitable process modeling language or software may be employed.

### BRIEF DESCRIPTION OF THE DRAWINGS

Some embodiments are illustrated by way of example and not limitation in the figures of the accompanying drawings in which:

FIG. 1 is a schematic block diagram of a process modeling system in example form, with the process modeling system interfaced with an enterprise system, in accordance with an example embodiment.

FIG. 2 is a schematic block diagram of process management application(s) forming part of the example process modeling system.

FIG. 3 is a schematic diagram of a data structure of process model information, according to an example embodiment.

FIG. 4 is a schematic diagram of an example role map forming part of the process model information of FIG. 3.

FIG. 5 shows example activity to role mapping information forming part of the data structure of FIG. 3, in accordance with an example embodiment.

FIG. 6 shows example employee to role category mapping information forming part of the data structure of FIG. 3, in accordance with an example embodiment.

FIG. 7 is a high-level schematic diagram of another example system for analyzing a process model.

FIG. 8 is a high-level view of a value chain forming part of an enterprise model according to an example embodiment.

FIG. 9 is a lower-level view of the example enterprise model of FIG. 8, diagrammatically showing functional decomposition of one of the elements of the value chain.

FIG. 10 is yet a lower-level view of the enterprise model of FIG. 8, diagrammatically illustrating the key processes in one of the functions of FIG. 9.

FIG. 11 is an example of a process model with each step in the logical process model mapped to a human resource role upon which it is dependent.

FIG. 12 is a schematic flow chart illustrating a method of managing a process, in accordance with an example embodiment.

FIG. 13 is an example bill of talent generated during the example process of FIG. 12.

FIG. 14 is an example skills projection report generated during the example process of FIG. 12.

FIG. 15 is a schematic flow chart illustrating a further example embodiment of a method for managing a process.

FIG. 16 is a schematic flow chart illustrating yet a further example embodiment of a method for managing a process.

FIG. 17 is a high-level flow chart of an example method of managing a process, which method may form part of the method of FIG. 12.

FIG. 18 is a diagrammatic representation of a machine in the example form of a computer system within which a set of instructions for causing the machine to perform any one or more of the methodologies discussed herein may be executed.

### DETAILED DESCRIPTION

Example methods and systems to generate a coded process model or enterprise model, and to perform automated analysis of the process model, are described. In the following description, for purposes of explanation, numerous specific details are set forth in order to provide a thorough understanding of example embodiments. It will be evident, however, to one skilled in the art that the present method and/or system may be practiced without these specific details.

According to an example embodiment, there is provided a system and method to model a process, using one or more processors. The method may include storing logical process model information defining logically structured process activities of the process, and associating human resource dependency information stored in the one or more databases with the logical process model information. The human resource dependency information indicates design-time dependency of the process activities on respective human resource components. The human resource dependency information may thus, for example, indicate that particular process activities of the logical process model information are dependent on associated human resource roles.

The human resource dependency information thus includes one or more role identifiers associated with at least some of the process activities, with each role identifier indicating a corresponding human resource role required for the performance of the associated process activity. The human resource dependency information further comprises a set of role category identifiers associated with at least one of the role identifiers. The set of role category identifiers indicates a plurality of alternative role categories which are applicable to the corresponding human resource role, with each instance of the associated process activity to be performed at runtime by a person satisfying a particular role category of the set. For example, a particular human resource role may have a role identifier “Engineer,” which may have an associated set of role category identifiers comprising “Electronic,” “Mechanical,” and “Chemical.”

The human resource dependency information may, in addition, comprise a plurality of sets of role category identifiers associated with the at least one role identifier, so that a particular role identifier is associated with two or more sets of role category identifiers, with the two or more sets of role category identifiers being mutually nonexclusive. In the above example, the human resource role for engineers may have a set of role category identifiers for the field of expertise (an example of which is recited above), and may have a set of role category identifiers for a level of experience to indicate experience (e.g., high, medium, or low). Human resource role dependency information may thus include two or more role attribute identifiers associated with at least one of the role identifiers to define respective attributes of the corresponding use of human resource role.

The method may include analyzing at least part of the logical process model information and the human resource dependency information to automatically generate a human resource requirement bill which includes a listing of human resource roles and role categories required for performance of the analyzed part of the process. Such a human resource requirement bill is also referred to as a bill of talent. The bill of talent may include not only a listing of personnel and organizational components directly involved in the execution of relevant process activities, but may also include personnel and organizational components involved in management, controlling and/or governance execution of the process activities. Management, control and governance layer of the relevant organization may thus also form part of the analysis and of the human resource requirement bill.

The method may, in addition, further include generating respective human resource requirement bills based, on the one hand, on the logical process model information and human resource dependency information, and, on the other hand, hypothetical logical process model information and human resource dependency information. The method may further comprise analyzing the respective human resource requirement bills to assess the human resource effect of the hypothetical logical process information. The method may thus include generating respective bills of talent for an as-is process and for a to-be process and comparing the results of the respective bills of talent.

The method may include automatically integrating the human resource dependency information and the human resource inventory information to ensure that values of the role category field in the human resource inventory information for a person having a particular role are limited to the set of role category identifiers associated with the corresponding role identifier in the human resource dependency information.

According to another embodiment, the method may instead or in addition provide automatically assigning, during runtime of the process, a particular person or persons to a specific process activity of an instance of the process, based at least in part on human resource inventory information and relevant instance-specific information. The human resource inventory information comprises a database of existing persons available for performance of the process, with the human resource inventory information including a role field and at least one role category field associated with respective persons.

The term “process” as used herein comprises a series of activities to produce a product or to perform a service, and is to be interpreted broadly as including a process group, a sub-process, or any collection of processes. Therefore, the totality of activities and/or processes which may be performed in an enterprise may also be referred to as a process. The process may include management, control and/or governance activities related to core activities that are to be executed to produce a defined output. In instances where the process model information is therefore with respect to an enterprise, such as a business enterprise, the process model information may thus be in the form of an enterprise model.

It is to be appreciated that the term “logical process model” refers to the depiction, specification, or mapping of a series of activities of an associated process, excluding process operationalization elements (e.g. IT system components, human resource information, and data dependency information).

### Architecture

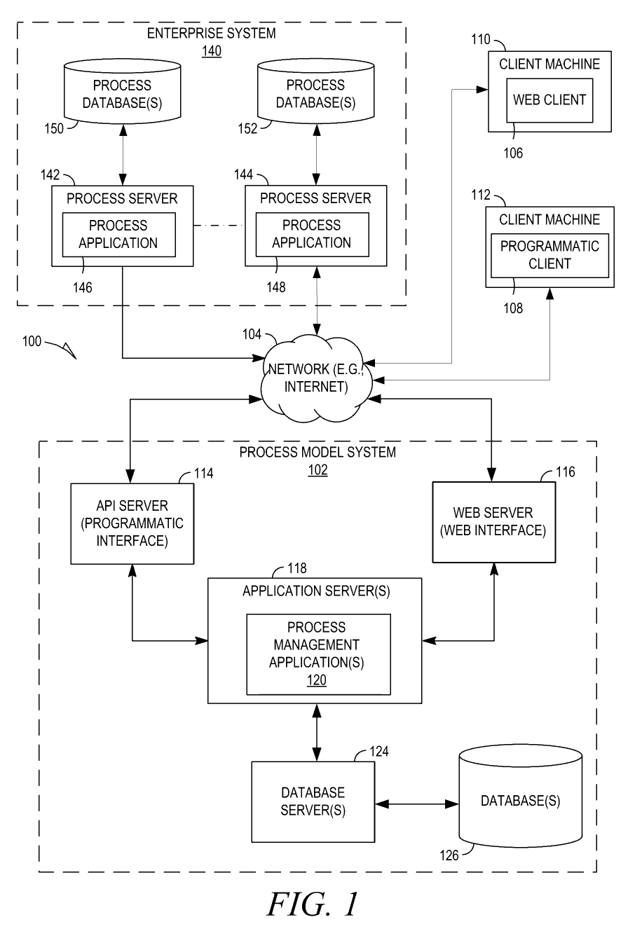

FIG. 1 is a network diagram depicting a client-server system 100, within which one example embodiment may be deployed. A networked process model system 102, in the example form of a dynamic process modeling system, provides server-side functionality, via a network 104 (e.g., the Internet, a Wide Area Network (WAN), or a Local Area Network (LAN)), to one or more clients. FIG. 1 illustrates, for example, a web client 106 (e.g., a browser, such as the Internet Explorer browser developed by Microsoft Corporation of Redmond, Washington State) and a programmatic client 108 executing on respective client machines 110 and 112.

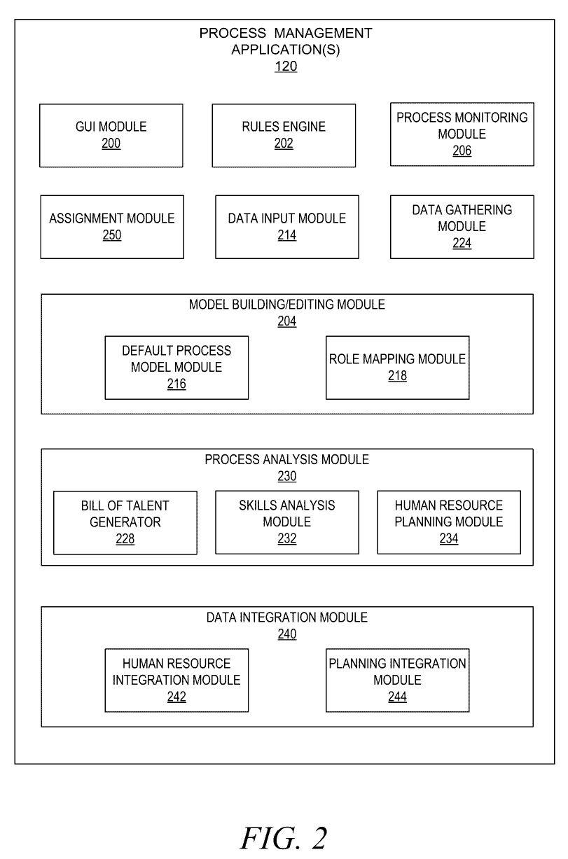

An Application Program Interface (API) server 114 and a web server 116 are coupled to, and provide programmatic and web interfaces respectively to, one or more application servers 118. The application servers 118 host one or more process management applications 120 (see FIG. 2); the process management applications are, in this example, enterprise model applications. The application server(s) 118 are, in turn, shown to be coupled to one or more database server(s) 124 that facilitate access to one or more database(s) 126.

The process model system 102 is also in communication with a process system which supports a process that is to be modeled by the process management application(s) 120 (e.g., business process models (BPM)). In the example embodiment, the process system is a client enterprise system, generally indicated by reference numeral 140, which supports a business enterprise. The process model system 102 of the example embodiment of FIG. 1 may therefore be an enterprise model system. The process management application(s) 120 may be in communication with components of an information technology (IT) system of the enterprise, in particular being in communication with a number of process servers 142, 144 forming part of the IT infrastructure of the client enterprise system 140. Each of the process servers 142, 144 supports one or more process applications 146, 148, and each process application 146, 148 provides functionalities employed in the performance of an associated activity or process supported by the enterprise system 140. Each process server 142, 144 may be in communication with one or more associated database(s) or process datastore(s) 150, 152, to read and/or write associated process data to the respective process datastore(s) 150, 152.

For example, process application 146 may be an accounting application, with the process data in the associated process datastore(s) 150 comprising client account information, while process server 144 may be a case management application, with the process data in the associated process datastore(s) 152 comprising records of respective cases processed by the enterprise system 140. It will be appreciated that the enterprise system 140 may typically comprise a greater number of process servers 142, 144 and process datastores 150, 152, but FIG. 1 shows only two such process servers 142, 144 for ease of explanation. It is further to be appreciated that communication and interfacing between respective process servers 142, 144 may occur via the network 104, while some of the process servers 142, 144 may be in direct communication.

The process management application(s) 120 may provide a number of functions and services to users that access the process model system 102, for example providing analytics, diagnostic, predictive and management functionality relating to system architecture, processes, and the activities of the enterprise supported by the enterprise system 140. Respective modules for providing these functionalities are discussed in further detail with reference to FIG. 2 below. While all of the functional modules, and therefore all of the process management application(s) 120 are shown in FIG. 1 to form part of the process model system 102, it will be appreciated that, in alternative embodiments, some of the functional modules or process management applications may form part of systems that are separate and distinct from the process model system 102. Such additional systems may, for example, include human resource management systems, quality management systems, business process management systems, and the like.

Further, while the system 100 shown in FIG. 1 employs a client-server architecture, the example embodiments are, of course, not limited to such an architecture, and could equally well find application in a distributed, or peer-to-peer, architecture system, for example. The process management application(s) 120 could also be implemented as standalone software programs, which do not necessarily have networking capabilities.

The web client 106 accesses the process management application(s) 120 via the web interface supported by the web server 116. Similarly, the programmatic client 108 accesses the various services and functions provided by the process management application(s) 120 via the programmatic interface provided by the API server 114.

### Process Management Application(s)

FIG. 2 is a block diagram illustrating multiple functional modules of the process management application(s) 120 of process model system 102. Although the example modules are illustrated as forming part of a single application, it will be appreciated that the modules may be provided by a plurality of applications The modules of the application(s) 120 may be hosted on dedicated or shared server machines (not shown) that are communicatively coupled to enable communications between server machines. The modules themselves are communicatively coupled (e.g., via appropriate interfaces) to each other and to various data sources, so as to allow information to be passed between the modules or so as to allow the modules to share and access common data. The modules of the process management application(s) 120 may furthermore access the one or more databases 126 via the database servers 124.

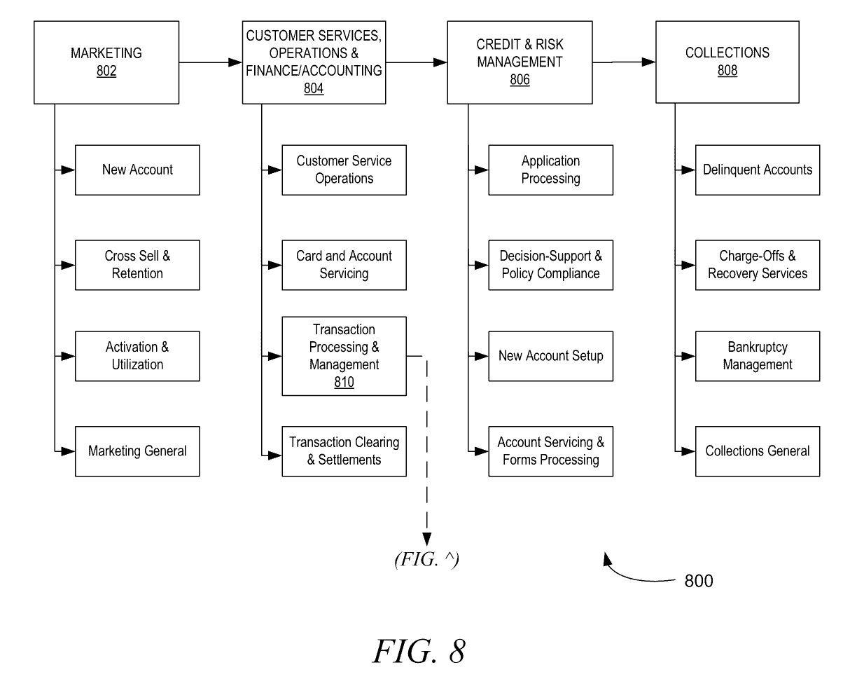

The process model system 102 may therefore provide a number of modules whereby a user may build or define a process model(s) or enterprise model for the enterprise system 140, monitor the execution of activities forming part of the process, and perform automated diagnostic or predictive analysis of the process model. A model building/editing module 204 is provided to enable a user or administrator to define an enterprise-specific process model, either by editing, adapting, or building on a selected default enterprise model, or by building an enterprise model from scratch. The model building/editing module 204 also enables the editing of the enterprise model in response to changes in the enterprise system 140 or the associated processes. As mentioned above, such an enterprise model is a process model which may represent sequences and relationships of business processes and business process activities, as well as relationships of such business process activities to human resource components, the IT infrastructure, process applications 146, 148, and process data. An example enterprise model is described in greater detail with reference to FIGS. 8-10 below.

The model building/editing module 204 may include at least one default process model module 216 to provide default process models. In instances where the process model is with respect to a business enterprise, the default process model module 216 may provide default business process models (BPM), which are to serve as bases for a user to define a business process model specific to the enterprise system 140. The default BPMs may be predefined by a supplier of the business process management application(s) 120 and are in respect to generic business processes relating to a variety of types of businesses or types of business activities. A user may thus, as a starting point for defining an enterprise-specific BPM, select one or more default process models which most closely approximate the business processes performed by the enterprise system 140. The default process model module 216 may typically provide default logical process models indicating a series of activities, without specific operationalization information indicating particular process elements or support elements on which the activities are dependent. The default process model module 216 may be configured to provide human resource dependency information, in order to associate particular default process activities with respective human resource roles. In some embodiments, the default process model module 216 may include default role category identifiers associated with each human resource role.

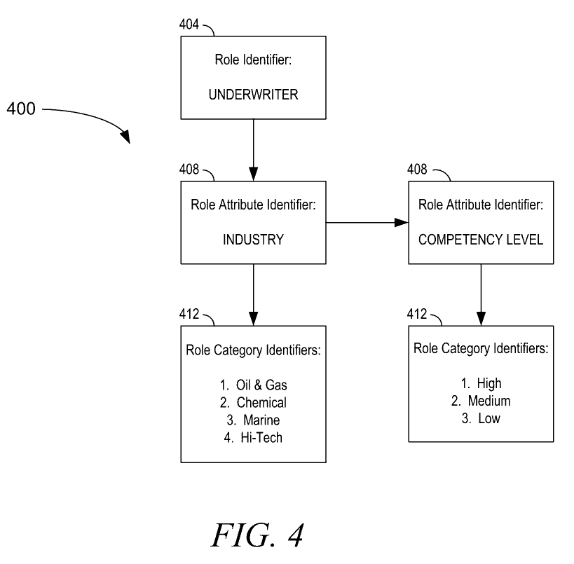

The model building/editing module may further include a role mapping module 218 to enable a user to create and/or edit sets of role category identifiers, associate sets of role category identifiers with corresponding role identifiers, and therefore create role maps for at least some human resource roles. An example role map is shown in FIG. 4 and is described in more particularity below.

The process management application(s) 120 further include a graphic user interface (GUI) module 200 to generate and manage an interactive GUI to display various aspects of the process model and to permit user management of the process model. In instances where all the processes of the enterprise system 140 are defined in a process model (e.g. instances where the process model is an enterprise model), it is typically not possible to display a representation of all of the processes and/or an entire business architecture in a single view, and the GUI will allow user selection of different levels or layers of the enterprise model for viewing. Such drill-down functionality is described in greater detail below with reference to FIGS. 8-10.

A data input module 214 provides functionality to permit the input of data for use in process model analysis. Information about scheduled downtime for the process applications 146, 148 and/or scheduled downtime for IT infrastructure elements may, for example, be inputted via the data input module 214. Similarly, in an example embodiment, human resource scheduling information, such as information about personnel availability (e.g. holiday calendars), may also be inputted into the process model system 102. The data input module 214 may be configured for manual input of this information, and may instead or in addition provide for automatic integration of scheduling data from other databases. For example, personnel unavailability data may automatically be obtained from a. Human Resources database (not shown) forming part of the enterprise system 140.

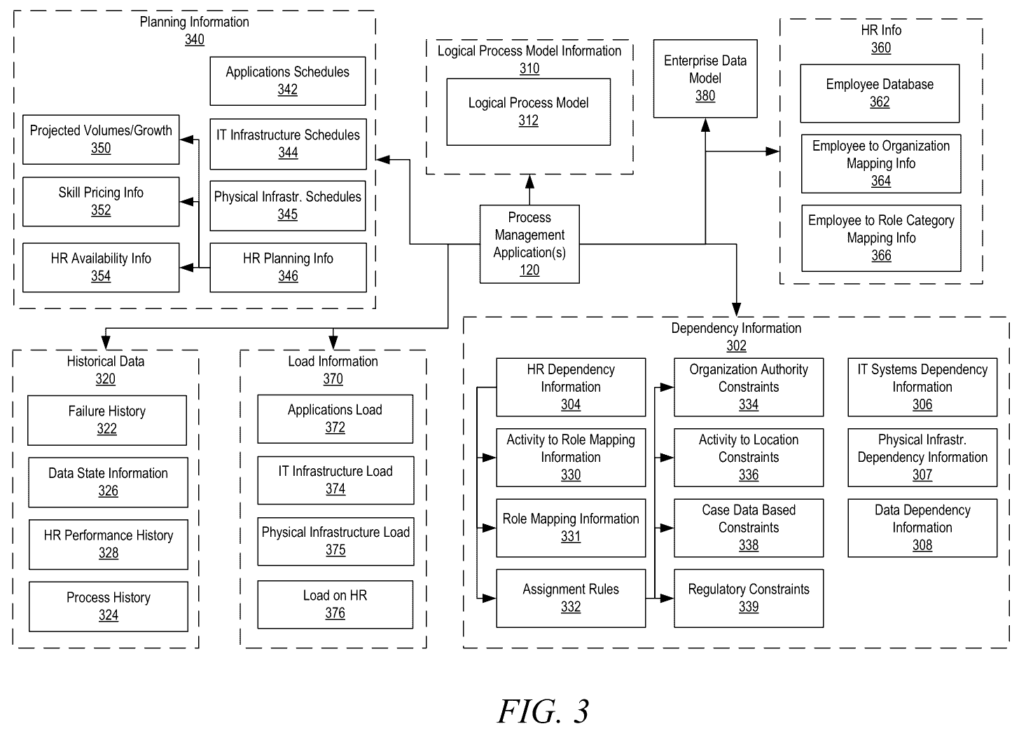

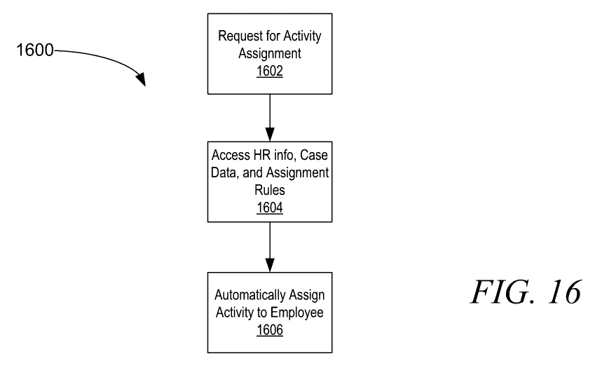

A rules engine 202 may be provided to permit the definition of assignment rules governing automatic assignment of process activities to particular employees. An example embodiment of such assignment rules 332 is described in greater detail below with reference to FIGS. 3 and 16.

The process management application(s) 120 may further include a data gathering module 224 to gather and collate information regarding the performance of respective processes and/or activities. To this end, the data gathering module 224 may cooperate with monitoring applications (not shown) installed in each of the process servers 142, 144 and/or client machines (not shown) forming part of the enterprise system 140. The process model system 102 may thus gather and record information regarding activities performed by respective elements forming part of the enterprise system 140.

To this end, the application(s) 120 may include a process monitoring module 206 to monitor performance of the processes defined in the enterprise model. Data gathered by the data gathering module 224 may thus automatically be compared to process activities that are scheduled according to the enterprise model in order to identify process event failures. The process monitoring module 206 may further compile historical data regarding system failures. Such historical data may, in particular, include applications process history, failure history, human resource (HR) performance history, and the like (examples of which are described with reference to FIG. 3 below).

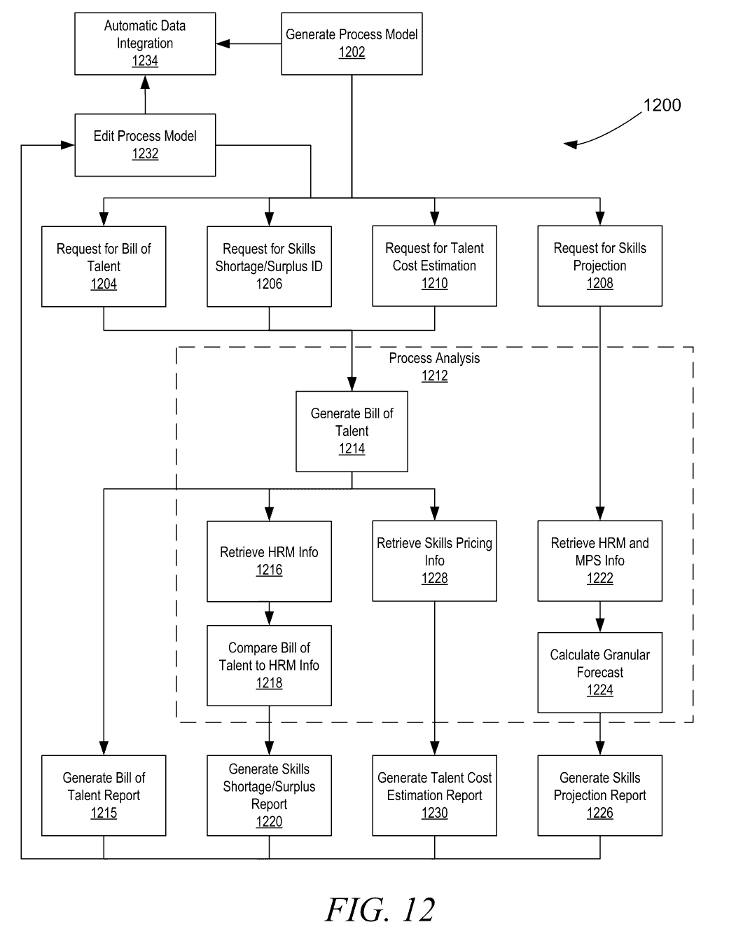

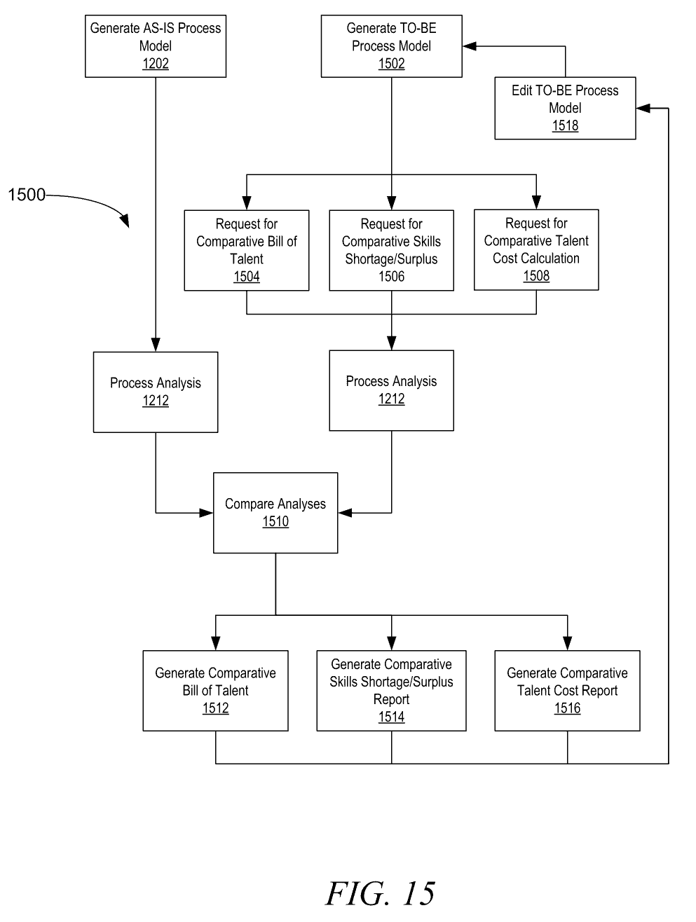

The process management application(s) 120 may yet further include a process analysis module 230 to perform analysis on the process model information and to generate various analysis reports. An example of such process analysis is described with reference to FIG. 12 below, and as indicated by reference numeral 1212. The process analysis module 230 may thus, for example, be configured to automatically generate, in response to user requests: a skills shortage/surplus report indicating disparities between human resources available to the organization and the bill of talent required to perform the process; a talent cost estimation report indicating an estimated cost of human resource components required for performance of the process, according to a corresponding bill of talent; a skills projection report that indicates estimated future human resource requirements; and the like. The process analysis module 230 may further be configured to generate comparative reports with respect to the above-mentioned aspects, as described in greater detail with reference to FIG. 15 below.

In the example embodiment illustrated in FIG. 2, the process management application(s) 120 may thus include a bill generator or bill of talent generator 228 to generate a human resource requirement bill in the form of a bill of talent. Such a bill of talent may include a listing of human resource roles and role categories required for performance of a selected process, activity, or part of the process. To facilitate process management, the process analysis module 230 may include a human resource planning module 234 to calculate forecasted human resource requirements based at least in part on the logical process information, human resource dependency information, and human resource planning information. The human resource planning information may include load information (see, for example, item 370 in FIG. 3 below) which may comprise a projected load on particular processes and/or activities defined in the enterprise model. By “load” is meant the amount of work performed by a process at a particular point in time or over a particular period. The load on a particular process or process activity may, for example, be calculated as a number of cases which is scheduled to be processed. A “case” is an instance of a process. For example, in a process for generating invoices, a particular case may refer to a specific invoice generated for a particular customer. The human resource planning module 234 may thus serve to project or estimate future loads on particular human resource roles and/or role categories, and may, for example, estimate respective percentages of growth, or caseload, expected for each of a plurality of role categories of a specific role.

The process analysis module 230 may further include a skills analysis module 232 to compare a bill of talent generated by the bill of talent generator 228 with human resource inventory information in order to identify human resource inventory shortages or surpluses. To this end, the human resource inventory information may comprise a database or listing of existing persons available for performance of the process. Such human resource inventory information may include a role field and at least one role category field associated with respective persons.

The process management application(s) 120 may further include a data integration module 240 to integrate role maps or human resource role categories throughout the process model system 102. The data integration module 240 may thus, for example, include a human resource integration module 242 to integrate human resource dependency information and human resource inventory information, to ensure that values of role category fields in the human resource inventory information for a person having a particular role are limited to the corresponding set of role category identifiers associated with respective role identifiers in the human resource dependency information. Human resource integration module 242 may additionally limit user input with respect to the association of human resource role categories with particular individuals in the human resource inventory information to values selected from a predetermined list. In an example embodiment, a user may be presented with a drop down menu in this respect, limited to predefined role category identifiers. The data integration module 240 may further include a planning integration module 244 to integrate, in similar fashion, the human resource planning information and the human resource dependency information, thus automatically providing data fields for estimated future activity volumes corresponding to each role category and/or role category combination indicated by the human resource dependency information.

An assignment module 250 may be provided to effect automatic assignment of a particular person or persons to a specific process activity or activities of an instance of the process. Such dynamic or automatic assignment may be based, at least in part, on the human resource inventory information and relevant instance specific information. The assignment of individuals to particular instances of process activities may further be based on relevant assignment rules and/or regulatory constraints, as explained further with reference to FIG. 16 below.

### Data Structures

FIG. 3 is an entity-relationship diagram, illustrating various tables, data repositories, or databases that may be maintained within the databases 126 (FIG. 1) and that may be utilized by the process management application(s) 120.

The databases 126 may thus include logical process model information 310, in this example being in respect of an enterprise model representative of the processes and activities performed by the enterprise system 140. The logical process model information 310 includes a logical process model 312, in this example being a logical enterprise model, comprising structured data defining the processes constituting the enterprise model and showing relationships between respective process activities constituting the respective processes. In the current example, the logical process model 312 may be a logical process model defining the sequence of process activities abstractly, without defining relationship of the activities or processes to process elements associated with operationalization of the process, which may be provided by dependency information 302. The logical process model 312 may reference failure definitions, which may include service-level agreements (SLAs) and key performance indicators (KPIs). The failure definitions, SLAs, and KPIs maybe user-specified.

Thus, the databases 126 may include dependency information 302 in process dependency repositories, with the dependency information 302 comprising structured information regarding dependencies of respective processes and/or process activities of the enterprise model. The dependency information 302 includes IT system dependency information 306 that comprises information regarding process dependency on IT system elements of the enterprise system 140. The IT system dependency information 306 may thus include information regarding the dependency of processes or activities on software such as process applications 146, 148, as well as dependency on IT infrastructure. The IT system dependency information 306 also includes datastore dependency information indicative of relationships between respective activities and datastores which are accessed in performance of the respective activities. The IT system dependency information 306 enables the generation of an interactive GUI displaying those process applications and process servers on which a selected process or process activity is dependent.

The dependency information 302 includes human resource dependency information 304 in which is stored structured information regarding the dependency of respective processes or process activities on particular human resource components. The human resource dependency information 304 may include role mapping information 331, in this example being in the form of role maps. The role mapping information 331 defines at least one set of role categories associated with each of a plurality of human resource roles that are required for the performance of the process, and is thus also referred to as role to role category mapping. An example role map 400 is shown in FIG. 4. The role map 400 is a data structure comprising a role identifier 404 describing the particular resource role to which the role map 400 pertains. In the present example, the role map 400 is with respect to the role of an underwriter. The role map 400 further includes role attribute identifiers 408 that define particular attributes of the associated role. In the example shown in FIG. 4, the role identifier “underwriter” is further defined by a role attribute identifier 408 “industry,” and a role attribute identifier 408 “competency level.” Each of the role attribute identifiers 408 has associated therewith a set of role category identifiers 412, which indicate a plurality of alternative role categories which are applicable to the corresponding human resource role and attribute. It can be seen with reference to FIG. 4 that a person performing the role of underwriter may be categorized, with respect to the role attribute of the industry in which that person is qualified, in one of the Oil & Gas, Chemical, Marine, or High-Tech fields. Each person performing the resource role of underwriter may also be categorized, with respect to the competency level attribute, as having a high, medium, or low competency level.

In the example illustrated with reference to FIG. 4, the role category identifiers 412 within a particular set of role category identifiers (e.g. being associated with a common role attribute identifier 408) are mutually exclusive, in that a particular person can be categorized in only one of these categories. In other examples, the role category identifiers 412 within a particular set may be mutually nonexclusive, so that a person may be categorized in more than one category at a particular time. The sets of role category identifiers 412 of FIG. 4 are, in this example, mutually nonexclusive, so that a particular person may simultaneously be associated with respective role category identifiers 412 selected from both sets of role category identifiers 412. Thus, for example, a person may be classified as an underwriter skilled in the Oil & Gas field and having a medium competency level.

In other embodiments, role maps 400 may be provided that do not arrange role category identifiers 412 by attribute, such as associating respective sets of role category identifiers 412 with respective role attribute identifiers 408 to achieve a hierarchical data structure, such as that of FIG. 4. In such instances, a role map 400 may comprise a role identifier 404 associated directly with a plurality of role category identifiers 412.

Although only a role map 400 of the underwriter role is illustrated, it should be appreciated that similar or analogous role maps 400 for each human resource role associated with the process may form part of the human resource dependency information 304. Although the role mapping information 331, in this example, forms part of the dependency information 302, the role mapping information 331 may, in other examples, be stored as part of the logical process model information 310, as part of human resource information 360, or as part of any other appropriate system or data structure.

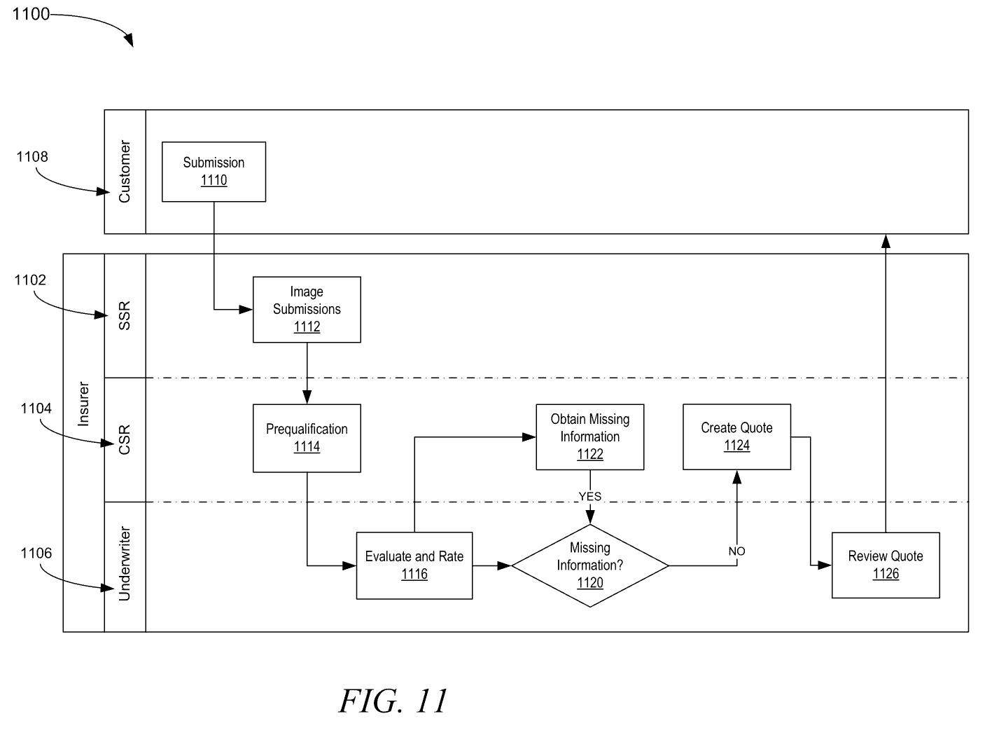

The HR dependency information 304 may further include activity to role mapping information 330 which associates respective process activities of the logical process model 312 with corresponding human resource roles. The activity to role mapping information 330 may thus indicate, for each activity, a particular process role responsible for performance of the activity. Turning briefly to FIG. 11, it will be seen that the activity to role mapping information 330 may, for example, associate an Image Submissions activity 1112 with the Shared Services Representative (SSR) role, associate the Evaluate and Rate activity 1116 with the Underwriter role, and so forth. In some embodiments, the activity to role mapping information 330 may comprise role identifiers 404 associated in a data structure with identifiers corresponding to respective activities or processes.

The human resource dependency information 304 may further include assignment rules 332, which may be used in the dynamic assignment of particular instances of process activities to individuals, as is described in greater detail with reference to FIG. 16 below. The assignment rules 332 may include case data based constraints 338, which specify assignment or constraint rules with respect to the assignment of particular activities based on case data. Such case data based constraints 338 may include assignment rules or constraints based on role categories of particular instances of the process. For example, an underwriter who specializes in a certain industry may be most conversant with the risks associated with that industry. An insurer may thus wish assignment of the Evaluate and Rate activity 1116 (FIG. 11) to be performed by matching the industry to which a particular instance of the process relates to a particular underwriter who is competent in the same industry. Assignments may likewise be made based on skill, knowledge, or competency level, experience of respective employees with particular customers, and the like. The assignment rules 332 may be customized or modified by the user at design-time by means of the rules engine 202. Assignment rules may be applicable process-wide, or may be specified to apply only to certain sub-processes, activities, or the like. The assignment rules 332 may yet further include activity to location constraints 336 that specify assignment of particular activities to employees or persons associated with specific locations. Organization authority constraints 334 may also be provided as part of the assignment rules 332. For example, a location of a particular may be matched to a geographical area for responsibility associated a particular person/role attribute. A sales assistant, e.g, may be required to be located within a minimum distance from the client location. Other location limitations or requirements may apply in different embodiments. Organizational authority constraints—for example maximum amount authorized, so that even if guy meets all other requirements, may be prohibited.

Regulatory constraints 339 may further form part of the assignment rules 332 to ensure dynamic assignment of activities in compliance with applicable regulations or legislation. The process of FIG. 11 may, for example, be performed in a regulatory environment that specifies that certain duties in an insurance quote production process be segregated (e.g., to ensure that payment is not entered and approved by the same individual). Such regulations may be reflected in the regulatory constraints 339 and may be automatically employed by the assignment module 250 during dynamic assignment.

Physical infrastructure dependency information 307 may also be included in the dependency information 302 to indicate the dependency of respective process activities on physical infrastructure components. Such physical infrastructure components may include, for example, vehicles, machinery, supply-chain elements, buildings, and the like.

The dependency information 302 may also include data dependency information 308. The data dependency information 308 may include data quality dependency information indicative of dependency of process activities on the quality of data in the one or more datastores which may be accessed in execution of respective activities. The data quality dependency information may be in respect of at least one direct datastore that may be accessed during execution of an associated activity, and may further be in respect of at least one indirect datastore, with one or more direct datastores being data flow dependent on the at least one indirect datastore, in that data may flow into the direct datastore from the indirect datastore, for instance, by means of data transfers or data synchronizations between the direct and indirect datastores. The data dependency information may also include data availability dependency information indicative of dependency of process activities on the availability of data in the one or more datastores that may be accessed in execution of respective activities. The data availability dependency information may include data element dependency information indicative of dependency of respective activities on particular data elements in the one or more datastores that may be accessed in execution of respective activities.

It will be appreciated that the logical process model information 310 and the dependency information 302 together provide process model information (or enterprise model information) defining a process architecture for the enterprise system 140, with the process architecture comprising, on the one hand, the processes and activities defined by the logical process model 312, and, on the other hand, information on the operationalization of the processes and activities as defined by the dependency information 302.

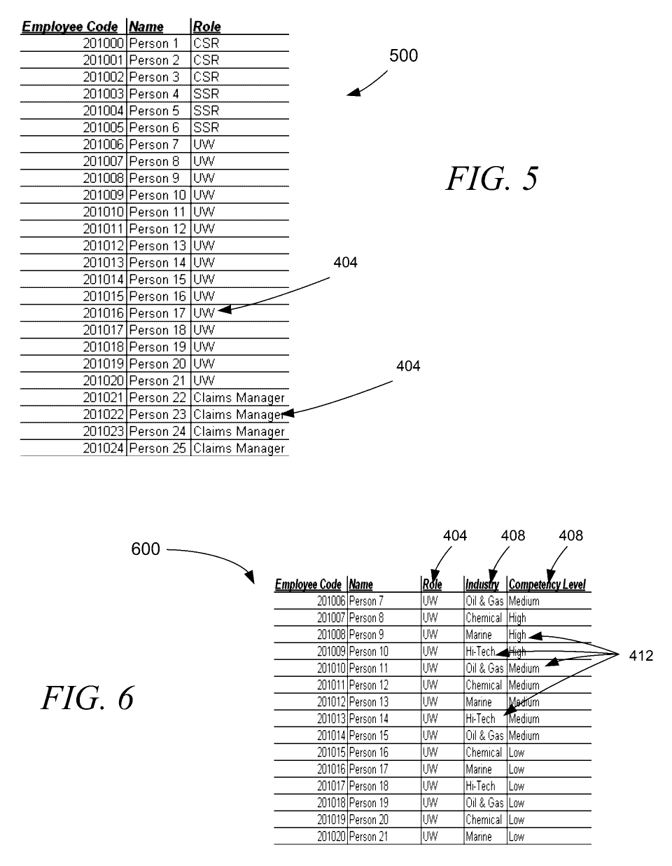

The database(s) 126 may further include human resource information 360. The FIR information 360 may include human resource inventory information in the example form of an employee database 362 listing all of the employees or individuals associated with the process. As used herein, the term employee includes not only permanent employees of the relevant organization, but also part-time employees or persons employed on a contract or ad hoc basis. The employee database 362 may indicate a role associated with each employee. To this end, the employee database 362 may include a role field associated with each employee record, with the value of each role field, in one example, being a predefined role identifier 404 stored in association with each employee. An example of such employee to role mapping 500 is shown in FIG. 5. The HR information 360 may further include employee to role category mapping information 366 to associate at least one role category to each employee who performs a role which has role categories defined therefor in the role mapping information 331. An example of such employee to role category mapping information 366 with respect to an underwriter role is shown in FIG. 6, indicated by reference numeral 600. In this example, the employee to role category mapping information 366 is in the form of a table in which each employee's record is carried in a corresponding row. The table has a column for a role identifier field 404 and, in this example, two columns for role category identifier fields 412. Each column for the role category identifiers 412 is for a role category identifier 412 selected from a corresponding set of role category identifiers 412 (see example role map 400 of FIG. 4), as indicated by the role attribute identifiers 408 at the headings of the respective columns. Each employee in the HR information 360 is therefore associated with at least one role category field that is populated by a role category identifier 412 selected from a corresponding set of role category identifiers 412. It should be noted that, as used herein, the term “role” is distinct from a corporate title, even though there may in some instances by coincidental overlap between an employee's corporate title and a role which is assigned to him. Also, for example, a single employee may in some embodiments be assigned multiple roles.

The HR information 360 further includes employee to organization mapping information 364 to associate each employee with a particular organization. Each employee may thus, for example, be assigned to a particular department or organization unit, business unit, line of business, business area, and/or geography area within the organization.

The database(s) 126 further comprise historical data 320 indicative of past performance of processes defined in the logical process model 312. The historical data 320 may preferably be gathered in real-time or near real-time, optionally being gathered upon performance of the respective processes or process activities. Instead, or in combination, the historical data 320 may be gathered at predefined times or intervals. The historical data 320 may be used for resource planning in which historical performance data is used in projecting or estimating future resource requirements. Such information may be provided by, inter alia, a human resource management system, a quality management system, and/or a business process management system, and may be gathered manually or automatically.

The historical data 320 may include process history 324 indicating performance parameters for historic performance of the process and/or of individual activities forming part of the process. The process history may, in this respect, include statistical values for historic performance of process activities, such as, for example, an average or a median time for each activity, as well as variances for each activity. It will be appreciated that some logical process models 312 may have a nonlinear structure, in which different instances of the process may follow different paths or series of activities. The process history 324 may thus include information with respect to a percentage of cases which take alternative paths within the process. The process history 324 may be category-specific, so that information is gathered and retained with respect to the relative or absolute volume of instances pertaining to specific categories. In the present example, the process history 324 may thus reflect the volume of instances of the process which are in the Oil & Gas industry, the Chemical industry, and so forth. Such category specific information gathering may apply to all aspects of the historical data 320.

The historical data 320 may further include failure history 322 indicative of the failure of various process elements, including, for example: failure of process applications 146, 148; failure of IT infrastructure elements, such as process servers 142, 144; and failure of physical infrastructure elements, such as vehicles, machinery, and the like. Human resource performance history 328 may also form part of the historical data 320 and may provide information regarding historical performance of particular human resource components such as personnel, personnel departments, operational units, and the like. The historical data 320 may further include data state information 326 with respect to historical information on particular data elements, data quality information, and the like.

Planning information 340 may be provided to facilitate human resource planning as well as risk analysis or predictive analysis. The planning information 340 may include: applications schedules 342 indicating scheduled unavailability or downtime of process applications 146, 148; IT infrastructure schedules 344 indicating scheduled unavailability of IT infrastructure elements or components, such as process servers 142, 144; and physical infrastructure schedules 345 indicating scheduled availability of physical infrastructure elements.

The planning information 340 may further include human resource planning information 346 to facilitate the planning of human resources. Human resource availability information 354 may include holiday calendars or personnel unavailability schedules, to indicate when personnel, people, or other human resource components supporting the process are scheduled for unavailability. Projected volume/growth information 350 may be provided for at least some of the human resource roles associated with the process, and may include information with respect to the projected volumes or growth in process caseload, as well as information with respect to the projected volumes or growth in the load on at least some, if not all, role categories of the respective human resource roles, as defined in the role mapping information 331. The human resource planning information 346 may yet further include skill pricing information 352 with respect to the present and/or future prices or costs of human resource components. The skill pricing information 352 may again be specific not only to respective human resource roles, but also to respective human resource role categories. Such pricing information enables calculation of the total cost of human resources required for performance of the process, which is also referred to as the cost of talent.

The databases 126 may furthermore include load information 370 regarding a current and a projected load on respective elements in the process. In particular, the load information 370 may include information on applications load 372 indicative of current load on process applications 146, 148; IT infrastructure load 374 indicative of current loads on the IT infrastructure of the enterprise system 140; physical infrastructure load 375 indicative of current loads on physical infrastructure elements; and information regarding current load on human resources 376. Provision of the load information 370 facilitates analysis of the business process model and may be particularly useful in load balancing management analysis.

An enterprise data model (EDM) 380 may be provided in cooperation with the process management application(s) 120. The EDM 380 may be a global data model for use by the process model system 102, and may serve as a “dictionary” or universal list of data element types, and the relationships between various data element types, to be used by the process model system 102. In some embodiments, role mapping information, or relationships between various roles, role attribute, and role categories may be contained in the EDM 380, to facilitate data consistency and promote data integration.

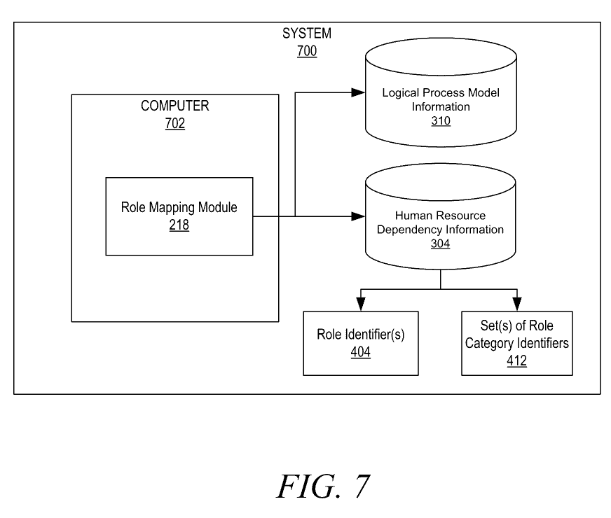

FIG. 7 is a high-level entity relationship diagram of another example configuration of a process model system 700. The system 700 may include a computer 702 that includes a role mapping module 218 to receive user input and to associate sets of role category identifiers 412 with corresponding role identifiers 404, thereby to create role maps such as those illustrated in FIG. 4, Like numerals indicate like elements in FIG. 3, FIG. 4, and in FIG. 7.

The system 700 includes a number of databases to store process model information, in particular comprising logical process model information 310 and human resource dependency information 304. The human resource dependency information 304 may indicate design-time dependence of process activities on respective human resource components, and may include one or more role identifiers 404 and associated set(s) of role category identifiers 412. It is to be noted that certain aspects of the methodologies and systems described herein, such as bill of talent generation at design-time, may be performed separately and independently from any enterprise system (such as system 140 in FIG. 1) that may be employed in actual performance of the process. It is to be noted that these databases are illustrated as separate entities, but that process model information 310 can instead be stored in a single database, or in a greater number of dispersed databases, while the process model information 310 may be stored either internally in the computer 700, or may be stored externally.

### GUIs

The concepts described above will now be further explained by way of example with reference to extracts from example GUIs that may be generated by the GUI module 200, according to an example embodiment. In FIG. 8, reference numeral 800 generally indicates an example graphical representation of a value chain diagram providing an overview of an example process defined by a process model. The value chain represents the chain of business activities that generate value for an enterprise. The example value chain diagram 800 is with respect to a business which provides credit card services to customers. The value chain diagram 800 represents a highest level of the enterprise model and comprises, at the highest level, a series of organizational units. In this example, the value chain diagram 800 comprises the organizational units of Marketing 802; Customer Services, Operations and Finance/Accounting 804; Credit and Risk Management 806; and Collections 808.

It is to be noted that, at the highest level of the value chain, different enterprises in a particular industry or field of business may be somewhat similar. For example, all computer chip manufacturing firms may have a similar sequence of elements, such as fabrication. However, the enterprise model includes further levels which indicate the organization of the particular enterprise, and in such low levels there may be great differences between respective enterprises in the same field. The particular organization of an enterprise may be influenced by the scale of operations, the history of the enterprise, and a variety of other factors. For instance, two cable TV companies operating in adjacent markets and offering near identical products may be completely different in their organization at lower levels. In other examples, the value chain diagram may decompose the enterprise process, at a high level, according to business domains. In this regard, “business domain” is understood as a particular line of business. For example, in a financial services organization, domains can include Deposits, Loans, Investments, and Insurance. Such domains can be further decomposed in sub-domains. A business domain of Loans can, for instance, be comprised of Corporate and Personal sub-domains.

As illustrated in FIG. 8, the value chain diagram 800 specifies the functional decomposition of each of the organizational units 802 to 808 in respective series of functions or processes. Thus, for example, the organizational unit of customer services, operations and finance/accounting 804 is comprised of a series of functions or processes. A user can view further organizational details or functional decomposition of each of the functional processes constituting the organizational unit 804 by selecting the associated function or process in the GUI. Organizational units may thus be categorized by the function they perform. It is to be noted that functions may be specific to a business domain/sub-domain, or may be shared across domains/sub-domains. For example, recruiting and other human resource functions may be shared functions, while, for instance, warehouse operations may be specific to a sales and distribution area of a large retailer.

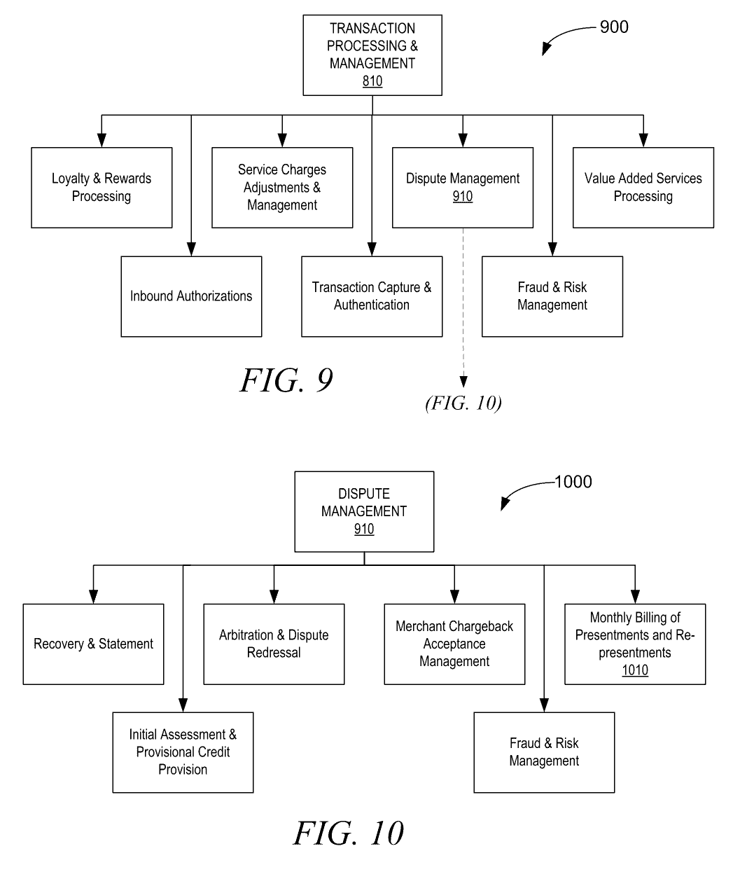

In FIG. 9, reference numeral 900 generally indicates functional decomposition of the function of Transaction Processing and Management 810, specifying a series of sub-functions that includes Dispute Management 910. The diagram 900 of FIG. 9 is thus a lower-level view of one of the functions forming part of the diagram 800 of FIG. 8, and it will be appreciated that each of the functions shown in FIG. 8 may similarly be viewed at a lower-level, or in greater magnification.

Likewise, diagram 1000 in FIG. 10 shows yet further functional decomposition of the sub-function of Dispute Management 910, which comprises a series of processes forming part of the Dispute Management 910 sub-function. One of these processes is Monthly Billing of Presentments and Re-Presentments 1010. A user can select any one of the processes of FIG. 10 to view a process model specifying a series of activities comprising the process, as well as dependency information of the process activities.

An example GUI 1100 representative of such an example process model for a New Business Quote process or sub-process is illustrated with reference to FIG. 11. It is to be noted that the process of FIG. 11 is an example process which is not a sub-process of the higher-level processes of FIGS. 8-10, but may be a sub-process of a different higher-level process, which is not illustrated. The user may thus drill down to a specific process model, as exemplified by the various levels of the enterprise model illustrated in FIGS. 8-10. The number of levels of the enterprise model may vary depending on the complexity of the enterprise.

The process model shown in GUI 1100 may include a logical process model indicating a sequence of activities 1110-1126. Human resource dependency information, in particular activity to human resource role mapping, is indicated in the GUI 1100 by location of blocks representing the activities 1110-1126 in one of a number of bands or “swim lanes” 1102-1108. In this example, the activities 1110-1126 are not defined in greater detail, but in other examples, some of the activities may be defined in greater detail (for instance, as a series of actions such as key strokes needed to perform the activity).

The example process is initiated by submission of an application for a quote, at operation 1110, by a customer 1108. Images relating to the subject matter of the quote application are thereafter prepared and submitted, at operation 1112, by a SSR 1102. A Customer Service Representative (CSR) 1104 then performs prequalification of the quote application, at operation 1114. The quote application is thereafter evaluated and rated, at operation 1116, by an underwriter 1106, whereafter it is determined, at operation 1120, whether or not there is any missing information in the quote application. If the quote location is incomplete, the missing information is obtained, at operation 1122, by the CSR 1104, and the operation of evaluating and rating the application, at operation 1116, is repeated. When it is determined, at 1120, that there is no missing information on the application, a quote is created, at operation 1124, by the CSR 1104, which is reviewed, at 1126, by the underwriter 1106 to complete the process.

### Flowcharts

An exemplary method will now be described with reference to FIG. 12, in which reference numeral 1200 generally indicates a flowchart illustrating a sequence of operations in the method. First, a user may generate a process model, at operation 1202, for a process such as, for example, the process illustrated with reference to FIG. 11. The process model may be generated by use of the default process model module 216 and model building/editing module 204 (FIG. 2). By use of these modules, the user may thus define logical process model information 310 (FIG. 3) and dependency information 302, including IT system dependency information 306, HR dependency information 304, physical infrastructure dependency information 307, and data dependency information 308.

Generation of the process model, at operation 1202, may thus include defining activity to role mapping information 330 and role mapping information 331 by use of the role mapping module 218. As explained above, each role identifier 404 indicates a corresponding human resource role required for performance of the associated process activity. The HR dependency information 304 may further include one or more sets of role category identifiers 412 associated with at least some of the role identifiers 404.

A user may thereafter enter a request for performance of process analysis with respect to human resource requirements for the modeled process. A series of example requests are illustrated in operations 1204-1210. Thus, for example, the user may request, at operation 1204, a bill of talent for the modeled process. The user may specify in the request, at operation 1204, a specific process, process activity, or series of process activities for which the bill of talent is to be generated.

The bill of talent is thereafter automatically calculated, at operation 1214, by the bill of talent generator 228. The bill of talent may comprise a list or catalog of human resource components, e.g. the number of persons, required in each of the predefined human resource roles, attributes, and categories, for performance of the relevant process. In some embodiments, the bill of talent provides a simple count of the number of persons required in each of the human resource roles and categories to perform a particular instance of the process, or to perform any one instance of the process. In other embodiments, the bill of talent may indicate the human resource requirements necessary to perform the process satisfactorily when subjected to the current or projected loads. To this end, the bill of talent generator 228 may determine the bill of talent based upon the logical process model information 310 and human resource dependency information 304, as well as on the planning information 340 and/or the load information 370 (FIG. 3). A bill of talent report is thereafter generated, at operation 1215

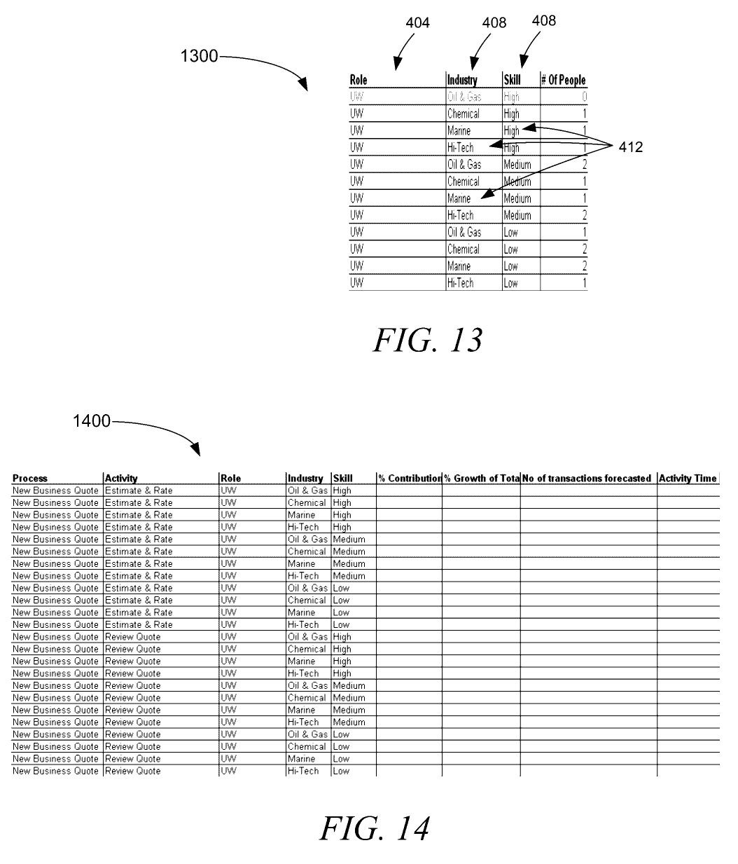

Instead of, or in addition to, indicating the number of persons required in each of a number of relevant role categories, the bill of talent may indicate the respective role category requirements by way of other suitable parameters. The bill of talent may, for example, indicate person-hours required in each category and/or a number of cases or instances expected to be handled by each category. An example bill of talent for the process of FIG. 11 is illustrated in FIG. 13. Like reference numerals indicate like parts in all of the drawings. It will be appreciated that the example bill of talent of FIG. 13 is with respect only to certain activities of the process, and that a bill of talent for the entire process illustrated in FIG. 11 would include at least some CSRs and SSRs.

A user may also request the identification of skills shortage or surplus, at operation 1206. The aim of such identification of skills shortage or surplus is to identify particular human resource roles and/or human resource role categories in which the enterprise has too many or too few employees (e.g. where the enterprise has a manpower shortage or surplus). Process analysis which is thus performed by the process analysis module 230 at operation 1212, in response to the request may include generation of the bill of talent, at operation 1214. Relevant human resource information is retrieved, at operation 1216, and is compared to the bill of talent, at operation 1218, by the skills analysis module 232 to identify human resource roles, human resource role categories, organizations, or locations, in which there may be an HR surplus or shortage. A skills shortage/surplus report is generated, at operation 1220, and displayed to the client.

A user may wish to edit the process model, at operation 1232, in response to the skills shortage/surplus report. Repetition of the generation of a skills shortage/surplus report for the edited or altered process model may allow a user iteratively to improve the design of the relevant process in order to more closely match the organization's human resources. Instead, or in addition, changes may, of course, be effected in the organization's human resources in response to the skills shortage/surplus report.

If any changes to the process model, at operation 1232, comprise changes to a role map 400 (FIG. 4), then the method may include automatic data integration by the data integration module 240 at operation 1234. The automatic data integration may comprise, harmonization of data fields in the human resource information 360, the planning information 340, the historical data 320, the load information 370, and/or the dependency information 302, and may thus be performed in part by the HR integration module 242 and the planning integration module 244. In certain embodiments, respective sources of information may form part of, for example, a manpower planning system, a quality management system or business process management system, a human resource management system, and a process modeling system, and data integration may be performed between two or more of these systems. When a user thus generates the process model, at operation 1202, or edits role mapping information 331, the data integration module 240 may ensure that corresponding changes are effected in the respective systems or sources of information mentioned above. Such data field integration promotes system wide data consistency, and may thus include integration with the enterprise data model 380. The data integration provides identical values, system wide, for role identifiers 404, role attribute identifiers 408, and role category identifiers 412. In some embodiments, the input of information such as the HR information 360, and particularly the employee to role category mapping information 366, may comprise presenting a user with a predetermined list of options, such as a drop down menu. For example, when a user of an HR system loads a new employee into the system, the user may be presented with a drop-down menu from which a particular role category identifier 412 for each role attribute is to be selected. Limiting user input to these predefined values for role category identifiers 412, role identifiers 404, and the like, ensures the entry of values limited to the values recorded in the role maps 400. The same approach of limiting user input to selection from a list of predefined values that are integrated across the various types and locations of information may be followed with respect to all of the information illustrated in FIG. 3, as well as any other appropriate information.

A user may alternatively request talent cost estimation, at operation 1210. Process analysis 1212 may in such case comprise generation of the bill of talent, at 1214, retrieval of relevant skills pricing information 352 at operation 1228, and the generation of a talent cost estimation report, at operation 1230, based on the bill of talent and the skills pricing information. The talent cost estimation report may provide estimated human resources costs with respect to a particular process, particular activities within a process, or cost particularized according to human resource roles or role categories. It will be appreciated that different role categories within a particular human resource role may have significantly variable costs. A highly skilled or experienced underwriter may, for example, cost considerably more than an underwriter with low skill or experience. Calculation of the cost of talent based on the particular role categories, and associated costs, is more accurate than would be the case if a statistical average value for the cost of underwriters generally were to be used. Process redesign or editing may again be performed, at operation 1232, to optimize the human resource costs.

A user may yet further request a skills projection, at operation 1208, to assess future human resource needs for the enterprise or organization with respect to a selected process. Process analysis 1212 may, in such a case, comprise retrieving, at operation 1222, information required to calculate estimated human resource requirements. Such information may include the logical process model information 310, projected volume/growth information 350, load on human resources information 376, and process history information 324. A granular human resource forecast is then calculated, at 1224, and a skills projection report is generated, at operation 1226. The projected volumes/growth information 350 may be at different levels of granularity with respect to the process model or enterprise model. Thus, for example, in some embodiments, a project growth rate may be provided with respect to broad organizational units of the value chain diagram 800 (see FIG. 8). A projected growth rate, for example, for the business area of customer services, operations, and finance/accounting 804 may be employed, through the relationship of a particular process (such as the process 1100 of FIG. 11) to the broader organizational unit as defined in the logical process model information 310. Projected requirements for human resource roles associated only with a lower-level process (e.g. process 1100) may thus be calculated based on projected growth for a higher-level process in the logical process model information 310. Similarly, cumulative projected growth for lower-level processes may be combined to calculate a projected growth for a higher-level process. Similar considerations apply to generating a bill of talent report, generating a skills shortage/surplus report, and generating a talent cost estimation report, and generates skill generating skills projection report.

An example format of such a granular skills projection report 1400 is shown in FIG. 14. It will be seen that the skills projection report 1400 of FIG. 14 is not populated with particular values, but serves merely to illustrate the format of an example report. The skills projection report 1400 may be granular or particularized in that it may provide projection of human resource requirements not only for a particular human resource role, but may instead, or in addition, provide forecasts for the requirements in each of a plurality of HR role categories. The example skills forecast report 1400 of FIG. 1400 shows a percentage contribution, a percentage growth, a number of transactions forecasted, and forecasted activity time for each role category identifier 412 associated with the human resource role “underwriter.”

A further example embodiment of the method is illustrated with reference to flow chart 1500 in FIG. 15. The method 1500 again commences with the generation or production of a process model, at operation 1202. In this example, the process model of operation 1202 is an as-is process model representing the process in its current form. The method also includes generating a to-be process model, at operation 1502. The to-be process model is a variation of the as-is process model, including alteration of certain process activities, dependency aspects, assignment rules, or the like. The to-be process model is thus a hypothetical alternative version of the as-is process model.

The user may thereafter request comparative analysis of the as-is process model and the to-be process model, at operations 1504-1508. The user may thus request generation of a comparative bill of talent, at operation 1504, request a comparative skills shortage/surplus analysis, at operation 1506, or request a comparative talent cost calculation, at operation 1508. In response to such requests, process analysis, at operations 1212, is performed separately on the as-is process model and on the to-be process model. The process analysis 1212, which is thus performed in the method 1500 of FIG. 15, is similar or analogous to the corresponding analysis 1212 of the method 1200 illustrated in FIG. 12.

The results of the respective process analyses are compared, at operation 1510, and a corresponding report is generated at operations 1512-1516. A comparative bill of talent may thus be generated, at operation 1512, to illustrate comparative bills of talent for the as-is process model and the to-be process model. Such a comparative bill of talent report may highlight variations in human resource requirements engendered by being proposed changes reflected in the to-be process model. As is the case with the bill of talent of method 1200, the comparative bill of talent report may be particularized or presented in granular fashion, so that the comparative human resource requirements are illustrated at a role category level. This applies to all of the reports generated in method 1500. A user may thus assess, for example, the human resource requirement changes caused by a proposed change to the process not only with respect to the number of employees required in a particular role, such as, for example, the number of underwriters required, but may be able to identify the effect of the proposed changes on specific role categories within a human resource role. A user may, for example, learn from the comparative bill of talent that a particular proposed change may cause a greater need for highly skilled or experienced underwriters, or for fewer underwriters experienced in the chemical industry. It will be appreciated that the generation of such comparative bills of talent may facilitate the optimization of the process with respect to scarce, expensive, or unavailable human resource role categories. If, for example, an organization has struggled to hire and retain underwriters skilled in the Oil & Gas industry, it may optimize the process by use of the iterative editing of the to-be process model and generation of comparative bills of talent to minimize the number of Oil & Gas underwriters required.

A comparative skills shortage/surplus report, generated at operation 1514, may likewise be used to assess the effect of proposed changes to the process on skills shortages or surpluses. A user may, for example, iteratively edit the to-be process model and generate comparative skills shortage/surplus reports to attempt to minimize or eliminate skills shortages and/or surpluses. The comparative skills shortage/surplus report may, of course, also assist with human resource planning when changes to an existing process are contemplated. Generation of a comparative talent cost report, at operation 1516, may similarly be employed in process redesign to minimize human resource costs. The process may thus include the operation of editing the to-be process model, at operation 1518, based on any of the respective reports.

FIG. 16 shows a flowchart depicting a method 1600 for automatic case assignment during runtime. The method 1600 comprises receiving a request for activity assignment, at operation 1602. The request may be generated by an operator, or may be automatically triggered by a process management application. It will be appreciated that the modeled process is, in use, performed repeatedly for respective orders or matters. Each such repetition of the processes is referred to as an instance of the process or as a case. At least some activities in each instance of the process have to be assigned to a particular individual or employee for performance of the activity, and the system 1600 may, in this instance, employ granular identification of role categories in the process model information, together with corresponding recording of applicable role categories for each employee in the human resource inventory information in the form of the HR information 360, to automatically select an appropriate employee for performance of that instance of the activity.

The process may thus include accessing the HR information 360, relevant case data, and assignment rules 332, at operation 1604, and automatically assigning the activity or the associated instance of the process to an employee, at operation 1606. Such dynamic or automatic activity assignment may, in some instances, be based simply on matching role category identifiers 412 in the HR information 360 and the relevant case data. Thus, for example, if the case data indicates that a particular instance of the process of FIG. 11 is with respect to the Oil & Gas industry, the assignment module 250 may automatically assign the case to an underwriter who is skilled in the Oil & Gas industry, as indicated by a matching role category identifier 412 in a corresponding data field of the HR information 360. Automatic activity assignment may in some embodiments be performed only for a subset of activities, which subset may be selected by a process designer. Functionality may be provided to permit manual or selective override of an automatic activity assignment to an operator or manager.

In other embodiments, automatic assignment may additionally be based on the applicable assignment rules 332. If, for example, applicable regulatory constraints 339 indicate that two particular activities in a process may not be performed by the same person, then the assignment module 250 may automatically note the identity of the employee assigned to the first of these activities, and may automatically assign the second of these two activities to a different employee. In other instances, the assignment rules may conversely stipulate assignment of multiple activities to the same employee.

The assignment rules may further be user-programmed to achieve particular aims, such as, for example, cost-effectiveness. For example, the assignment rules 332 may be customized to cause assignment of activities to a least expensive employee, subject to the regulatory constraints 339. Such cost-conscious assignment will naturally apply particularly where employees are employed on time-based or case-based remuneration. The assignment rules 332 may be programmed further to consider, for example, experience of employees with a particular customer to which the case pertains, particular organizations with which the employee is associated, respective locations of the employee and other entities involved in the performance of the process, and similar considerations.

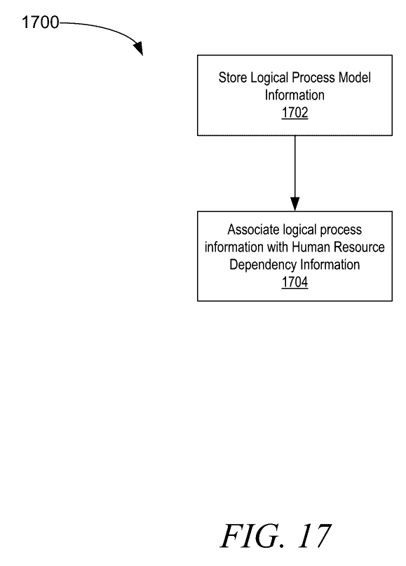

In FIG. 17, flowchart 1700 is a high-level depiction of another example embodiment of modeling a process. The method comprises storing, at operation 1702, logical process information in one or more databases, with the logical process model information defining logically structured process activities of the process. The method further comprises associating, at operation 1704, the logical process model information with human resource dependency information in order to indicate design time dependence of the process activities on respective human resource components. The human resource dependency information comprises one or more role identifiers 404 (FIG. 4) associated with at least some process activities forming part of the logical process model information, with each role identifier 404 indicating a corresponding human resource role required for the performance of the associated process activity. The human resource dependency information further comprises a set of role category identifiers 412 associated with at least one of the role identifiers 404, in order to indicate a plurality of alternative role categories which are applicable to the corresponding human resource role. Each instance of the associated process activity is to be performed at runtime by a person satisfying a role category forming part of the set.

Example systems and methods as described above provide automatic bill of talent generation with respect to a modeled process. The bill of talent provides information with respect to human resource requirements specified by role categories within respective human resource roles. Skills shortages or surpluses may automatically be identified by the generation of a skills shortage/surplus report performed at a role category level. The accuracy of automatic talent cost estimation reports is additionally enhanced by the fact that such cost estimation is performed with the differentiation of role category requirements, thus reflecting variation in cost between role categories.

Role category differentiation by use of, for example, role maps 400 further enable augmented dynamic assignment of activities in particular instances of the process to appropriate human resource components, while the consideration of assignment rules and regulatory constraints improves the effectiveness and customizability of automatic dynamic assignment.

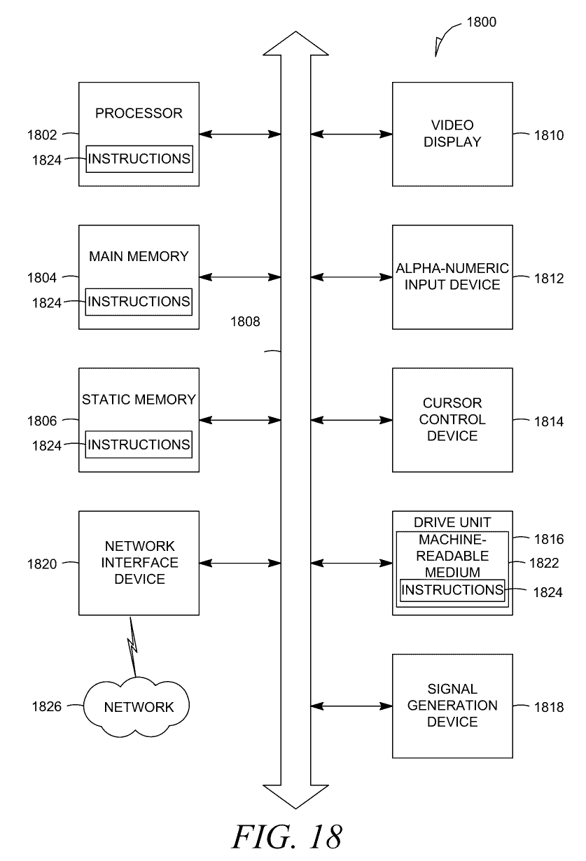

FIG. 18 shows a diagrammatic representation of machine in the example form of a computer system 1800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU), or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a cursor control device 1814 (e.g., a mouse), a disk drive unit 1816, a signal generation device 1818 (e.g., a speaker) and a network interface device 1820.

The disk drive unit 1816 includes a machine-readable medium 1822 on which is stored one or more sets of instructions (e.g., software 1824) embodying any one or more of the methodologies or functions described herein. The software 1824 may also reside, completely or at least partially, within the main memory 1804 and/or within the processor 1802 during execution thereof by the computer system 1800, with the main memory 1804 and the processor 1802 also constituting machine-readable media.

The software 1824 may further be transmitted or received over a network 1826 via the network interface device 1820.

While the machine-readable medium 1822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present method. The term “machine-readable medium” shall accordingly be taken to include, but not be limited to, solid-state memories, optical and magnetic media, and carrier wave signals.

Thus, a method and system to perform analysis of a process supported by a process system have been described. Although the present system and method have been described with reference to specific example embodiments, it will be evident that various modifications and changes may be made to these embodiments without departing from the broader spirit and scope of the method and/or system. Accordingly, the specification and drawings are to be regarded in an illustrative rather than a restrictive sense.

The Abstract of the Disclosure is provided to comply with 37 C.F.R. 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A processor-implemented method to execute on one or more processors that perform the method, the method comprising:
storing in one or more databases logical process model information defining logically structured process activities of a process; and
storing in the one or more databases one or more role identifiers forming part of human resource dependency information that indicates design-time dependence of the process activities on human resource components, the one or more role identifiers being associated with at least some of the process activities, with each role identifier indicating a corresponding human resource role required for performance of the associated process activity;
storing in the one or more databases a set of role category identifiers forming part of the human resource dependency information, the set of role category identifiers being associated with at least one of the role identifiers and indicating a plurality of alternative role categories which are applicable to the corresponding human resource role, each instance of the associated process activity to be performed at runtime by a person satisfying a particular role category of the set.

2. The processor-implemented method of claim 1, wherein the human resource dependency information comprises a plurality of sets of role category identifiers associated with the at least one role identifier, so that a particular role identifier is associated with two or more sets of role category identifiers, the two or more sets of role category identifiers being mutually nonexclusive.

3. The processor-implemented method of claim 2, wherein the human resource dependency information includes two or more role attribute identifiers associated with at least one of the role identifiers to define respective attributes of the corresponding human resource role, each role attribute identifier having associated therewith an associated set of role category identifiers.

4. The processor-implemented method of claim 3, wherein the two or more role attribute identifiers indicate attributes comprising field of expertise, competence level, experience level, or location.

5. The processor-implemented method of claim 1, further comprising analyzing at least part of the logical process model information and the human resource dependency information to automatically generate a human resource requirement bill which includes a listing of human resource roles and role categories required for performance of the analyzed part of the process.

6. The processor-implemented method of claim 5, further comprising generating respective human resource requirement bills based, on the one hand, on the logical process model information and human resource dependency information, and, on the other hand, hypothetical logical process model information and human resource dependency information, the method further comprising analyzing the respective human resource requirement bills to assess the human resource effect of the hypothetical logical process information.

7. The processor-implemented method of claim 5, further comprising comparing in automated fashion the human resource requirement bill with human resource inventory information to identify human resource inventory shortages or surpluses, the human resource inventory information comprising a database of persons available for performance of the process, the human resource inventory information including a role field and at least one role category field associated with respective persons.

8. The processor-implemented method of claim 7, further comprising integrating the human resource dependency information and the human resource inventory information to ensure that values of the role category field in the human resource inventory information for a person having a particular role are limited to the set of role category identifiers associated with the corresponding role identifier in the human resource dependency information.

9. The processor-implemented method of claim 7, wherein the human resource inventory information includes costs associated with respective role categories and/or role category combinations, the method further comprising automatically calculating a human resource cost based on a corresponding human resource requirement bill.

10. The processor-implemented method of 1, further comprising automatically calculating forecasted human resource requirements based at least in part on the logical process information, the human resource dependency information, and human resource planning information, the human resource planning information comprising estimated future activity volumes of respective role categories and/or role category combinations.

11. The processor-implemented method of 10, further comprising integrating the human resource planning information and the human resource dependency information to automatically provide data fields for estimated future activity volumes corresponding to each role category and/or role category combination indicated by the human resource dependency information.

12. The processor-implemented method of 1, further comprising automatically assigning, during runtime of the process, a particular person or persons to a specific process activity of an instance of the process, based at least in part on human resource inventory information and relevant instance-specific information, the human resource inventory information comprising a database of existing persons available for performance of the process, the human resource inventory information including a role field and at least one role category field associated with respective persons.

13. A system comprising:
at least one database to store process model information, the process model information comprising:
logical process model information defining logically structured process activities of a process;
human resource dependency information stored in the one or more databases, to indicate design-time dependence of the process activities on respective human resource components, the human resource dependency information comprising:
one or more role identifiers associated with at least some of the process activities, each role identifier indicating a corresponding human resource role required for the performance of the associated process activity; and
a set of role category identifiers associated with at least one of the role identifiers, the set of role category identifiers indicating a plurality of alternative role categories which are applicable to the corresponding human resource role, each instance of the associated process activity to be performed at runtime by a person satisfying a particular role category of the set, and
a role mapping module to receive user input and to associate sets of role category identifiers with corresponding role identifiers based on the user input.

14. The system of claim 13, wherein the human resource dependency information comprises a plurality of sets of role category identifiers associated with the at least one role identifier, so that a particular role identifier is associated with two or more sets of role category identifiers, the two or more sets of role category identifiers being mutually nonexclusive.

15. The system of claim 14, wherein the human resource dependency information includes two or more role attribute identifiers associated with at least one of the role identifiers to define respective attributes of the corresponding human resource role, each role attribute identifier having associated therewith an associated set of role category identifiers.

16. The system of claim 15, wherein the two or more role attribute identifiers indicate attributes selected from a field of expertise, a competence level, an experience level, or a location.

17. The system of claim 13, further comprising a bill generator to analyze at least part of the logical process model information and the human resource dependency information to generate a human resource requirement bill which includes a listing of human resource roles and role categories required for performance of the analyzed part of the process.

18. The system of claim 17, wherein the bill generator is to generate respective human resource requirement bills based, on the one hand, on the logical process model information and human resource dependency information, and, on the other hand, hypothetical logical process model information and human resource dependency information, the system further comprising a hypothetical analysis module to analyze the respective human resource requirement bills, to assess the human resource effect of the hypothetical logical process information.

19. The system of claim 17, further comprising a skills analysis module to compare the human resource requirement bill with human resource inventory information in order to identify human resource inventory shortages or surpluses, the human resource inventory information comprising a database of existing persons available for performance of the process, the human resource inventory information including a role field and at least one role category field associated with respective persons.

20. The system of claim 19, further comprising a human resource integration module to integrate the human resource dependency information and the human resource inventory information, to ensure that values of the role category field in the human resource inventory information for a person having a particular role are limited to the set of role category identifiers associated with the corresponding role identifier in the human resource dependency information.
